(19) United States
(12) Patent Application Publication
(10) Pub. No.: US 2008/0056969 A1
(43) Pub. Date: Mar. 6, 2008

(54) Agricultural hygienic chamber

(76) Inventors: Daisaburo Makihara, Ichikawa-City (JP); Banjo Mitsui, Yokohama-City (JP)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/894,244

(22) Filed: Aug. 20, 2007

(30) Foreign Application Priority Data
Sep. 1, 2006 (JP) 2006-237511

(51) Int. Cl. A23L 3/3409

(52) U.S. Cl. 422/292

(57) ABSTRACT

The present invention relates to an agricultural hygienic chamber assembly for use in the hygiene of fresh fruits or fresh vegetables and, as a representative example, to an agricultural hygienic chamber well suited for use when fresh fruits or fresh vegetables are treated with, for example, preservatives for maintaining freshness.

This application claims the benefit of priority under 35 U.S.C. §119(e) of Japanese Patent Application No. 2006-237511 filed on Sep. 1, 2006.

### TECHNICAL FIELD

The present invention relates to an agricultural hygienic chamber assembly for use in the hygiene of fresh fruits or fresh vegetables and, as a representative example, to an agricultural hygienic chamber well suited for use when fresh fruits or fresh vegetables are treated with, for example, preservatives for maintaining freshness.

### BACKGROUND ART

Patent References 1 to 4 disclose chamber assemblies having structures related to the present invention. In these structures, a cover sheet such as a bag-shaped sheet is stretched over the outside of the outer surface of any structural frame assembly, or panels are inserted inside of the openings of the structural frame assembly.

The floor is a structure that exposes the ground directly to the interior of the chamber or assembles an elevated floor on a floor frame.

Patent Reference 1

Examined Japanese Utility Model Publication No. S52-61735, Vinyl House Assembly

Patent Reference 2

Examined Japanese Utility Model Publication No. S57-1543, Small Greenhouse

Patent Reference 3

Examined Japanese Utility Model Publication No. S58-155958, Heat Retaining Box Assembly

Patent Reference 4

Unexamined Japanese Patent Publication No. 2001-333648, Simple Greenhouse

### BRIEF DESCRIPTION OF THE DRAWINGS

FIG. 1 is a perspective view of the agricultural hygienic chamber related to the present invention.

FIG. 2 is a lateral cross-sectional view showing the agricultural hygienic chamber using an air tube as the elastic ring before the air intake.

FIG. 3 is a lateral cross-sectional view showing the agricultural hygienic chamber using an air tube as the elastic ring after the air intake.

FIG. 4 is a lateral cross-sectional view showing the agricultural hygienic chamber using a solid elastic ring as the elastic ring.

FIG. 5 is a horizontal cross-sectional view sliced at the airtight seal part of the agricultural hygienic chamber using an air tube provided with an intake and an exhaust valve as the elastic ring and is a view showing the state before air intake into the same tube.

FIG. 6 is a horizontal cross-sectional view showing a slice at the airtight seal part of the agricultural hygienic chamber using an air tube provided with an intake and an exhaust valve as the elastic ring and a view showing the state after air intake into the same tube.

FIG. 7 is a lateral cross-sectional view of the strategically placed parts forming the bag-shaped cover sealed airtight with air intake via the intake and exhaust valve of the air tube shown above in FIG. 2.

FIG. 8 is a lateral cross-sectional view of the agricultural hygienic chamber showing the elastic ring holding the peripheral edge of the opening of the bag-shaped cover.

FIG. 9 is a lateral cross-sectional view of the agricultural hygienic chamber with the above-mentioned bag-shaped cover formed by a rigid cover able to hold its shape.

### LIST OF THE REFERENCE NUMERALS

1 base sheet

2 bag-shaped cover

3 construction surface

4 opening

5 peripheral edge of the opening

6 fastener groove

7 elastic ring

8 molded walls of the fastener groove

9 flange

10 air tube

11 solid elastic ring

12 air intake and exhaust valve

13 inner peripheral wall

14 outer peripheral wall

15 adhesion surface

16 adhesion surface

17 step

18 base groove

19 seal segment

20 release part

### DISCLOSURE OF THE INVENTION

Problems to be Solved by the Invention

When the structure has a cover sheet stretched over the outside of the outer surface of the structural frame assembly forming the chamber, one problem is that the cover sheet is damaged within a short time by the parts in contact with the corners of the structural frame. The cover sheet is restricted by the characteristic structural frame assembly, and a design that yields to the structural frame assembly is required. This cover sheet becomes difficult to use when the dimensions of the structural frame assembly are large. In general, the problem is the time it takes to complete the tasks of covering and disassembling.

Particularly in a hygienic chamber for producing hygienic fresh fruits under a gas atmosphere for maintaining freshness, airtight seals against the ambient atmosphere and the ground are required. However, the agricultural chambers represented by the above-mentioned Patent References 1 to 4 have structures that have difficulty in ensuring airtight seals against the ambient atmosphere and the ground.

Means to Solve the Problem

The present invention provides an inexpensive agricultural hygienic chamber assembly having a simple structure that is very easy to assemble and disassemble, and can easily form an airtight structure against the ambient atmosphere and the construction surface, such as the ground. Consequently, the present invention can reliably form the airtight seal required for hygienic gas treatment, such as to preserve freshness.

The key points are now described. The agricultural hygienic chamber related to the present invention has a base sheet and a bag-shaped cover, and the base sheet is laid on a construction surface such as the ground. The opening of the above-mentioned bag-shaped cover faces downward, and the above-mentioned opening is closed by the base sheet. The peripheral edge of the opening of the above-mentioned bag-shaped cover is inserted into an annular fastener groove formed on the top surface of the peripheral edge of the above-mentioned base sheet. The peripheral edge of the opening of the above-mentioned bag-shaped cover is tightly secured to a molded wall of the annular fastener groove by an elastic ring placed inside of the above-mentioned annular fastener groove and is sandwiched and held between the elastic ring and the molded wall of the annular fastener groove.

The above-mentioned bag-shaped cover is comprised of a flexible sheet material typified by a flexible composite resin sheet material and can be used by leaning it against the hygienic products stored in the chamber. Alternately, the top of the bag-shaped cover is suspended when being used.

As an alternative, the above-mentioned bag-shaped cover is formed from a rigid sheet material and thus maintains the bag-shaped state, for example, a composite resin sheet material of the same rigidity.

Similarly, the above-mentioned base sheet is made of a flexible sheet material typified by a flexible composite resin sheet material and can be made to adhere tightly by adapting to the construction surface which is not level.

The peripheral edge of the above-mentioned base sheet forms a flange that projects out from a molded part of the above-mentioned fastener groove, that is, the opening of the bag-shaped cover, to the side and lies on the construction surface, such as the ground; it can maintain the airtight seal with the construction surface in the outer region of the chamber and be built more stably on the construction surface.

The above-mentioned elastic ring is formed from an air tube, for example. The above-mentioned air tube uses a tube having pressurized air sealed in beforehand. A preferred example is an air tube capable of introducing and removing air after inflation with pressurized air.

In addition to the above-mentioned air tube, a solid elastic ring is made of rubber material or an elastic ring made of a solid interface substance such as sponge is used.

As an example of forming the above-mentioned annular fastener groove, the inner peripheral wall and the outer peripheral wall opposite the above-mentioned inner peripheral wall stand upright from the top surface of the peripheral edge of the above-mentioned base sheet, and the above-mentioned annular fastener groove can be formed between the above-mentioned outer peripheral wall and inner peripheral wall.

As a preferred example, the structure has release parts for allowing the release of the above-mentioned elastic ring at strategically chosen locations in the above-mentioned outer peripheral wall. When the elastic ring is clamped onto the inner peripheral surface or outer peripheral surface of the opening of the bag-shaped cover and compressed and deformed, the local sections of the elastic rings are freed from the release parts to the outside and the deformations are absorbed. Therefore, an airtight seal is ensured between the peripheral edge of the opening of the bag-shaped cover and the elastic ring.

Effects of the Invention

The agricultural hygienic chamber which is the object of the present invention can be formed by only laying a base sheet on a construction surface such as the ground, inserting the peripheral edge of the opening of the bag-shaped cover into a fastener groove, and applying pressure via the elastic ring, and is very easily assembled and disassembled.

In addition, the airtight structure of the agricultural hygienic chamber can be easily formed and is effective as a hygienic chamber based on using hygienic gas for agricultural products that demand a high level of airtightness. An ideal application is a hygienic chamber in which fresh fruits or fresh vegetables are treated with agents to preserve freshness or to remove astringency.

Assembly is possible where the structural frame assembly in the conventional examples is not used, damage to the sheet caused by the above-mentioned structural frame assembly is eliminated, and restrictions caused by the structural frame assembly are not present.

### BEST MODE FOR CARRYING OUT THE INVENTION

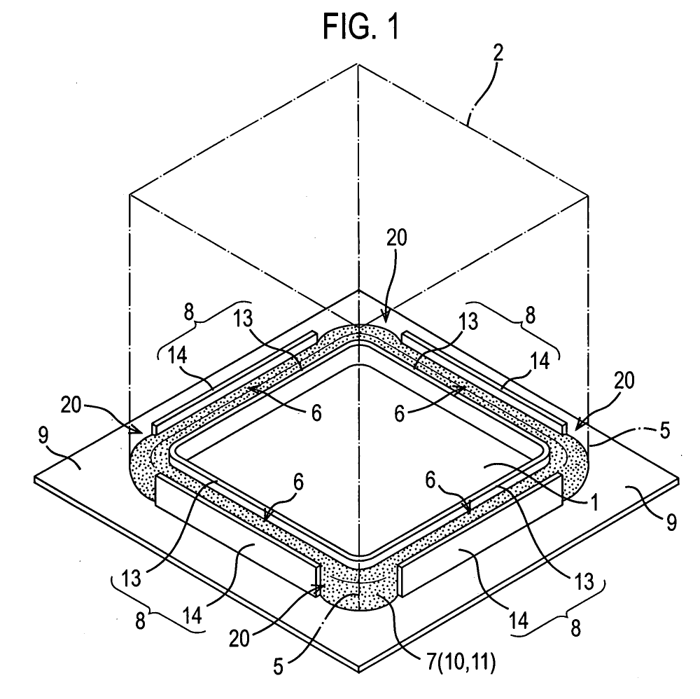

Specific examples of the above-mentioned agricultural hygienic chamber are explained based on FIG. 1 to FIG. 9.

The numeral 1 denotes a nearly flat base sheet laid on the construction surface 3 such as the ground or a concrete floor. The numeral denotes a bag-shaped cover that can cover and be removed from the above-mentioned base sheet 1.

The above-mentioned bag-shaped cover 2 has a structure where opening 4 thereof faces downward, and the above-mentioned opening 4 is closed by the base sheet 1; the peripheral edge 5 of the opening of the above-mentioned bag-shaped cover 2 is inserted into annular fastener groove 6 formed on the top surface of the peripheral edge of the above-mentioned base sheet 1; and peripheral edge 5 of the opening of the above-mentioned bag-shaped cover 2 is tightly secured to molded wall 8 of the annular fastener groove by elastic ring 7 placed inside of the above-mentioned annular fastener groove 6 and is sandwiched and held between elastic ring 7 and molded wall 8 of the annular fastener groove.

The above-mentioned bag-shaped cover 2 is formed from flexible sheet material that allows folding; a good example is a composite resin sheet material. As another example, bag-shaped cover 2 is formed from a cloth sheet material or a paper sheet material that is flexible and is coated or impregnated with an airtight sealing material.

Preferably, the above-mentioned flexible sheet material uses a transparent or semi-transparent sheet material through which the hygienic agricultural products are visible.

The above-mentioned bag-shaped cover 2 made of a flexible sheet material is used by leaning the cover against the hygienic agricultural products stored in the chamber while covering the products or suspending the top of bag-shaped cover 2 depending on the usage state.

The above-mentioned flexible sheet material may be formed from compound sheet materials, for example, compound sheet materials of composite resin sheet materials and cloth sheet materials. In addition, fiber-reinforced sheet material embedded with threads or a mesh can be used.

As another example, the above-mentioned bag-shaped cover 2 is formed from composite resin sheet material or glass sheet material having the rigidity that is necessary to hold the bag shape. In other words, the bag-shaped state is assumed by a sheet material able to hold its own shape.

Similarly, the above-mentioned base sheet 1 is formed from flexible sheet material, good examples being composite resin sheet material or rubber sheet material. Because of the flexibility, the sheet can be tightly secured and folded up to adapt to construction surface 3 that is not level.

As another example, the above-mentioned base sheet 1 is formed from a rigid sheet material, for example, from composite resin sheet material or glass sheet material. Moving the agricultural hygienic chamber and assembly with bag-shaped cover 2 is easy.

Preferably, the peripheral edge of the above-mentioned base sheet 1 forms a flange 9 that projects out sideways from the part forming the above-mentioned fastener groove 6, that is, from opening 4 of bag-shaped cover 2, and is laid on construction surface 3, such as the ground. Bag-shaped cover 2 can be more stably laid down and more stably supported on construction surface 3 on the outside region of the chamber, or can be carried by the flange 9 and moved, and weights placed on flange 9.

As an example of forming the above-mentioned annular fastener groove 6, inner peripheral wall 13 and outer peripheral wall 14 opposite the above-mentioned inner peripheral wall 13 stand upright from the top surface of the peripheral edge of the above-mentioned base sheet 1. The above-mentioned annular fastener groove 6 can be formed between the above-mentioned inner peripheral wall 13 and outer peripheral wall 14.

The above-mentioned inner peripheral wall 13 and outer peripheral wall 14 are appropriate as molded walls 8 of the above-mentioned fastener groove. The above-mentioned elastic ring 7 is compressed while being restricted by the above-mentioned inner or outer peripheral wall 13, 14. The reaction force therefrom clamps the peripheral edge 5 of the opening of bag-shaped cover 2 to inner peripheral wall 13 or outer peripheral wall 14.

The above-mentioned inner peripheral wall 13 and outer peripheral wall 14 have the rigidity to appropriately compress elastic ring 7 and not be deformed excessively by the reaction force. For example, base sheet 1 is formed from a thin flexible sheet, and thick inner peripheral wall 13 and thick outer peripheral wall 14 stand upright from the top surface of the above-mentioned base sheet 1.

Alternately, the entire base sheet 1 is formed from a rigid sheet material, and inner peripheral wall 13 and outer peripheral wall 14 that are rigid and are integrated with the sheet material and stand upright.

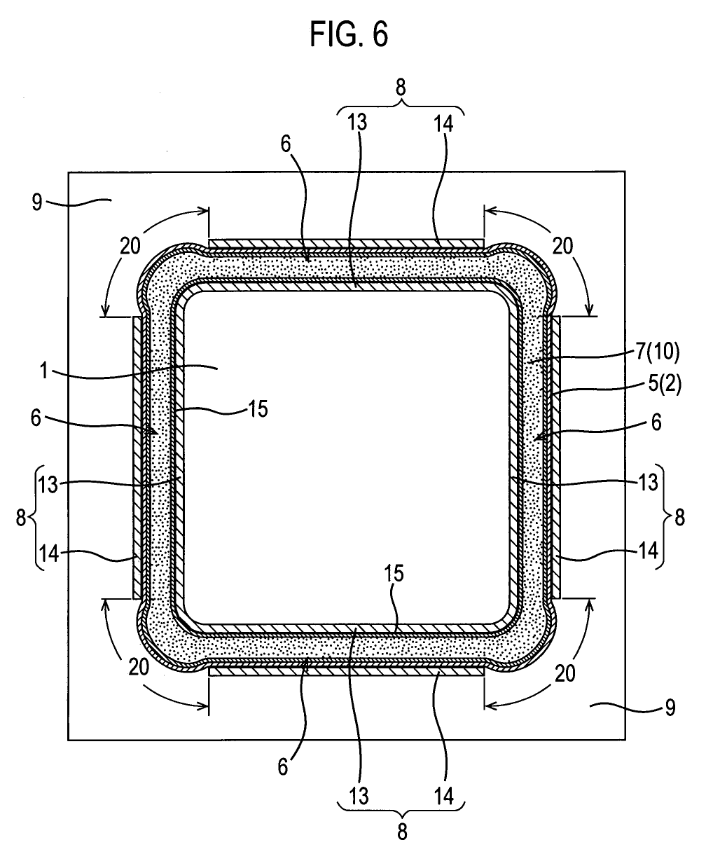

Preferably, as shown in FIG. 6, for example, the structure has release parts 20 for allowing the release of the above-mentioned elastic ring 7 formed at strategically chosen locations of the outer peripheral wall 14, for example, at the corners of the above-mentioned outer peripheral wall 14. When the elastic ring 7 is adhered by pressure to the inner peripheral surface or the outer peripheral surface of the opening of bag-shaped cover 2, and compressed and deformed, the local sections of elastic ring 7 are freed from the release parts and move to the outside, and deformations are absorbed. Therefore, a tight hold is maintained between peripheral edge 5 of the opening of bag-shaped cover 2 and elastic ring 7.

The above-mentioned elastic ring 7 is, for example, air tube 10. The above-mentioned air tube 10 is a tube that has pressurized air sealed in beforehand. A preferred example is air tube 10 capable of introducing and removing the air after inflation via the intake of pressurized air. In other words, air tube 10 provided with an air intake and exhaust valve 12 is used.

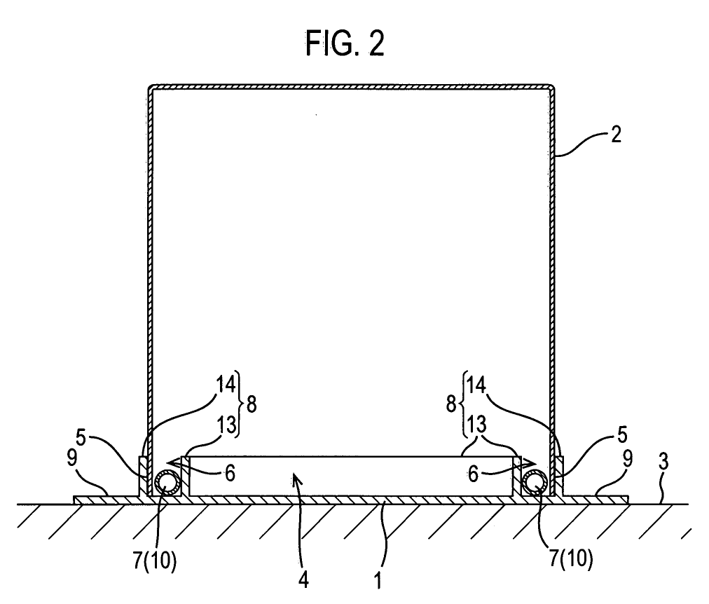

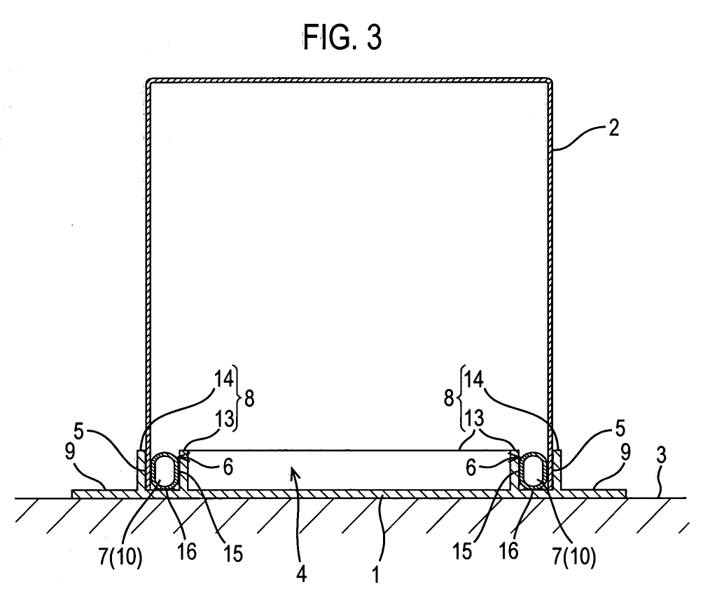

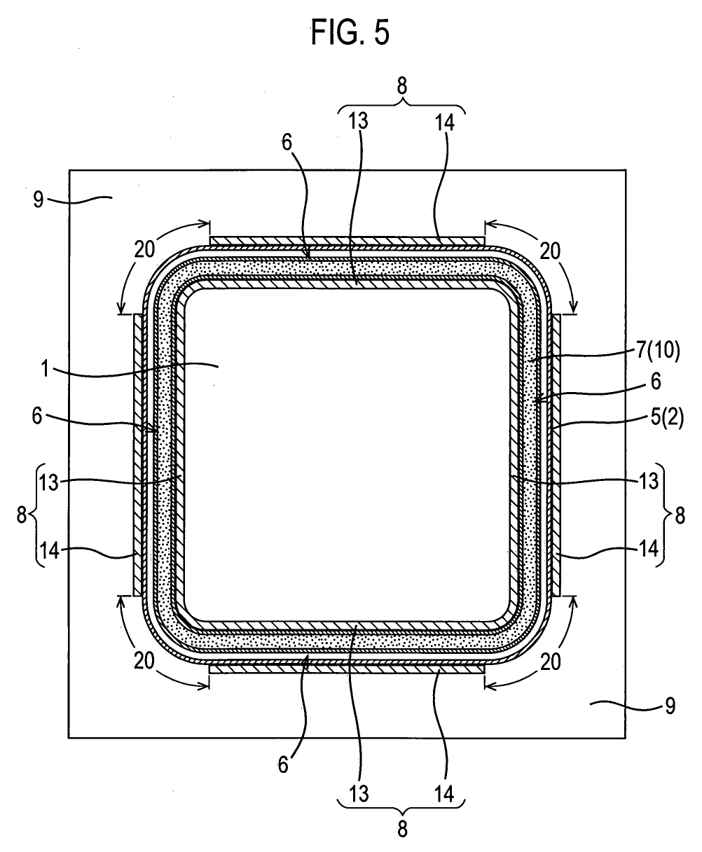

When air tube 10 provided with the above-mentioned air intake and exhaust valve 12 is used, as shown in FIG. 2 and FIG. 5, the above-mentioned air tube 10 in the exhausted state is loosely fitted beforehand inside the fastener groove 6. Next, peripheral edge 5 of the opening of bag-shaped cover 2 is loosely inserted between air tube 10 and outer peripheral wall 14 or inner peripheral wall 13. Next, as shown in FIGS. 3, 6, and 7, the air intake is through intake and exhaust valve 12 to achieve full inflation. By the reaction force therefrom, peripheral edge 5 of the opening of bag-shaped cover 2 applies pressure and tightly adheres to outer peripheral wall 14 or inner peripheral wall 13, and an airtight sealing state of bag-shaped cover 2 is formed.

Simultaneously, the above-mentioned air tube 10 is directly secured tightly by an adhesion surface 15 to the inner peripheral wall 13 or outer peripheral wall 14 (molded walls 8 of the fastener groove) on the side surface opposite the side in contact with peripheral edge 5 of the opening of bag-shaped cover 2; the lower surface of the same tube 10 has pressure applied and is tightly secured by adhesion surface 16 to the base wall of molded walls 8 of the fastener groove and improves the airtight seal of the above-mentioned bag-shaped cover 2, and is sandwiched and held between air tube 10 (elastic ring 7) and molded wall 8 of the annular fastener groove (outer peripheral wall 14 or inner peripheral wall 13) while enabling installation and removal.

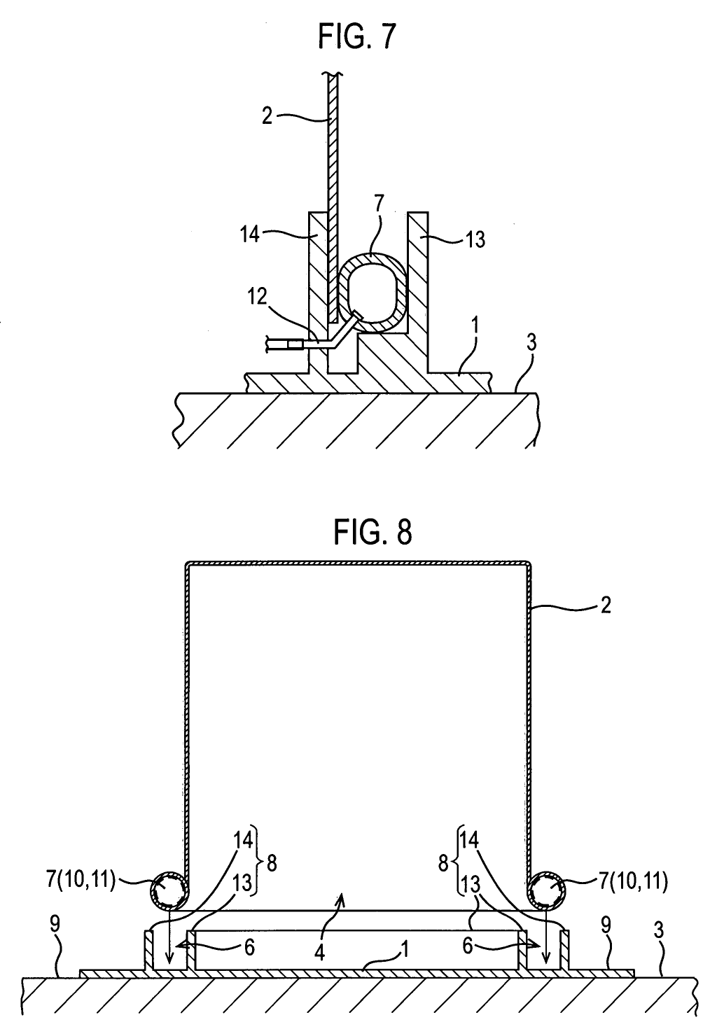

As illustrated in FIG. 7, intake and exhaust valve 12 of the above-mentioned air tube 10 is supported by inner peripheral wall 13 or outer peripheral wall 14. The intake and exhaust apparatus connects to the above-mentioned intake and exhaust valve 12, and performs the air intake and maintains the air filled state. Intake and exhaust valve 12 is compressed, or an object like a pin is inserted into intake and exhaust valve 12 to stimulate the exhaust. Intake and exhaust valves 12 having this function are known, such as the intake and exhaust valve of an automobile tire or the intake and exhaust valve of an inner tube.

When air tube 10 with pressurized air sealed in beforehand is used, for example, air tube 10 is compressed and pressed together with peripheral edge 5 of the opening of bag-shaped cover 2 into the above-mentioned fastener groove 6. Or after peripheral edge 5 of the opening of bag-shaped cover 2 is inserted, air tube 10 is pressed into the same fastener groove 6. Then by the reaction force of the above-mentioned air tube 10, peripheral edge 5 of the opening of the above-mentioned bag-shaped cover 2 is tightly secured to molded wall 8 of the annular fastener groove, that is outer peripheral wall 14 or inner peripheral wall 13, and is sandwiched and held between air tube 10 (elastic ring 7) and molded wall 8 of the annular fastener groove (outer peripheral wall 14 or inner peripheral wall 13) while allowing for installation and removal.

As shown in FIG. 7, as means for improving the airtight seal produced by elastic ring 7 represented by the above-mentioned air tube 10, step 17 that projects partially from the base wall of fastener groove 6 into the same groove 6 is provided and elastic ring 7 is supported by the above-mentioned step 17. On the other side, peripheral edge 5 of the opening of bag-shaped cover 2 is loosely inserted into base groove 18 formed between the above-mentioned step 17 and molded wall 8 of the fastener groove. The added pressure of elastic ring 7 and the added pressure accompanying air intake by air tube 10 are applied to peripheral edge 5 of the same opening from the end to a higher part of peripheral edge 5 of the opening of bag-shaped cover 2, and the airtight action is reliably obtained.

When inner peripheral wall 13 and outer peripheral wall 14 standing upright from the top surface of the above-mentioned base sheet 1 are provided, the above-mentioned step 17 is formed integrated with the base of inner peripheral wall 13 or outer peripheral wall 14. The above-mentioned base groove 18 is formed between the above-mentioned step 17 and outer peripheral wall 14 or inner peripheral wall 13.

FIGS. 1 to 7 illustrate the case where elastic ring 7 represented by air tube 10 is inserted on the inner peripheral wall 13 side of molded walls 8 of the fastener groove, and peripheral edge 5 of the opening of bag-shaped cover 2 is inserted on the outer peripheral wall 14 side of molded walls 8 of the fastener groove. Although not shown in the drawings, peripheral edge 5 of the opening of bag-shaped cover 2 can be inserted on the outer peripheral wall 14 side of molded walls 8 of the fastener groove or into the inner peripheral wall 13 side of molded walls 8 of the fastener groove.

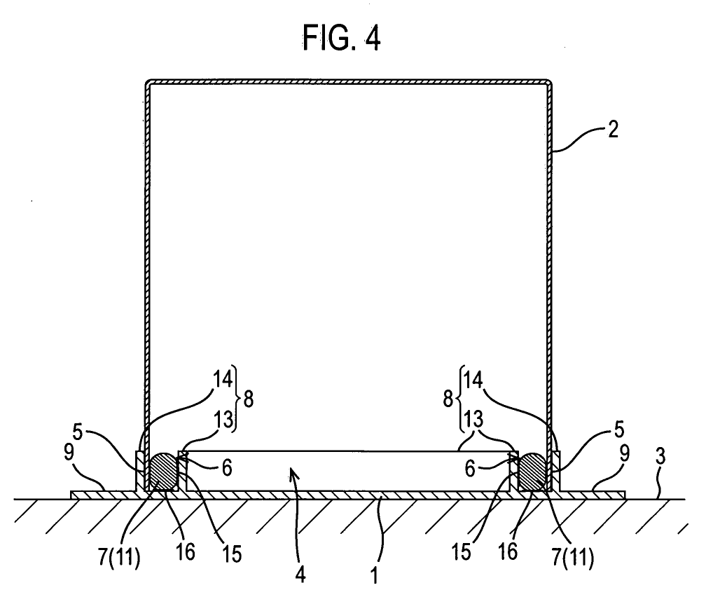

As shown in FIG. 4, instead of the above-mentioned air tube 10, solid elastic ring 11 comprised of a rubber material having compressible elasticity as the base material or elastic ring 11 comprised of a solid interface material such as sponge is used. Elastic ring 11 comprised of the above-mentioned rubber or sponge may have a through-hole for adjusting the compressible elasticity at the shaft center.

The above-mentioned solid elastic ring 11 has a larger cross-sectional area than fastener groove 6 and is compressed by pressing into the same groove 6. Peripheral edge 5 of the opening of the above-mentioned bag-shaped cover 2 is tightly secured to molded wall 8 of the annular fastener groove by the reaction force of the ring and is tightly secured to molded wall 8 of the fastener groove at another part to produce the airtight sealing state. Simultaneously, the edge is sandwiched and held between elastic ring 11 and molded wall 8 of the annular fastener groove.

As shown in FIG. 8, the above-mentioned air tube 10 filled beforehand with air or solid elastic ring 11 secures and holds the outer peripheral surface or the inner peripheral surface of peripheral edge 5 of the opening of bag-shaped cover 2. The above-mentioned air tube 10 and solid elastic ring 11 are pressed into fastener groove 6 together with peripheral edge 5 of the opening of bag-shaped cover 2.

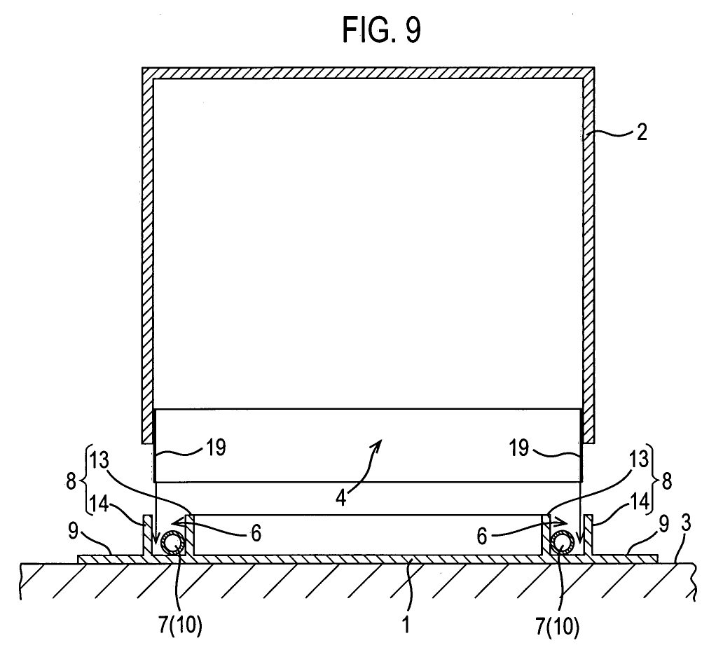

As shown in FIG. 9 illustrating the forming of the above-mentioned bag-shaped cover 2 by a rigid cover that holds its shape, flexible annular seal segment 19 is provided on the inner peripheral surface or the outer peripheral surface of opening 4 of the above-mentioned rigid bag-shaped cover 2. The above-mentioned seal segment 19 is inserted into fastener groove 6 and can be pressed tightly to molded wall 8 of the fastener groove by elastic ring 7 comprised of air tube 10 or solid elastic ring 1 1.

We claim:

1. An agricultural hygienic chamber comprised of a base sheet and a bag-shaped cover where the opening of said bag-shaped cover faces downward, and said opening is closed by the base sheet; the peripheral edge of the opening of said bag-shaped cover is inserted into an annular fastener groove formed on the top surface of the peripheral edge of said base sheet; the peripheral edge of the opening of said bag-shaped cover is tightly secured to a molded wall of said annular fastener groove by an elastic ring situated inside the annular fastener groove, and is sandwiched and held between the elastic ring and the molded wall of the annular fastener groove.

2. The agricultural hygienic chamber according to claim 1, wherein said base sheet and bag-shaped cover are comprised of flexible sheet materials.

3. The agricultural hygienic chamber according to claim 1, wherein the peripheral edge of said base sheet projects out from the molded part of said fastener groove to the side to form a flange.

4. The agricultural hygienic chamber according to claim 1, wherein said elastic ring is comprised of an air tube.

5. The agricultural hygienic chamber according to claim 1, wherein an inner peripheral wall and an outer peripheral wall opposite the inner peripheral wall stand upright from the top surface of the peripheral edge of said base sheet as the molded walls of said annular fastener groove, and said annular fastener groove is formed between said outer peripheral wall and said inner peripheral wall.

6. The agricultural hygienic chamber according to claim 5, wherein release parts for allowing the release of said elastic ring are molded at strategically placed parts of said outer peripheral wall.
